(19) United States
(12) Patent Application Publication
(10) Pub. No.: US 2005/0123784 A1
(43) Pub. Date: Jun. 9, 2005

(54) Terminal having surface layer formed of Sn-Ag-Cu ternary alloy formed thereon, and part and product having the same

(75) Inventor: Shigeki Miura, Osaka (JP)

Correspondence Address: BIRCH STEWART KOLASCH & BIRCH, PO BOX 747, FALLS CHURCH, VA, 22040-0747, US

(73) Assignee: FCM CO., LTD.

(21) Appl. No.: 11/000,046

(22) Filed: Dec. 1, 2004

(30) Foreign Application Priority Data
Dec. 2, 2003 (JP) 2003-402837(P)

(51) Int. Cl. B21D 39/00; B32B 15/01

(52) U.S. Cl. 428/624; 428/643; 428/646; 428/647

(57) ABSTRACT

A terminal obtained by forming a surface layer formed of an Sn—Ag—Cu ternary alloy with electroplating on a whole surface or a portion of a conductive base, wherein the Sn—Ag—Cu ternary alloy is constructed with a ratio of 70-99.8 mass % of Sn, 0.1-15 mass % of Ag and 0.1-15 mass % of Cu, has a melting point of 210-230° C., and is formed in a state of a crystal of a minute particle as compared with the surface layer formed of Sn alone.

This nonprovisional application is based on Japanese Patent Application No. 2003-402837 filed with the Japan Patent Office on Dec. 2, 2003, the entire contents of which are hereby incorporated by reference.

### BACKGROUND OF THE INVENTION

1. Field of the Invention

The present invention relates to a terminal (for example, a connector terminal, a relay terminal, a slide switch terminal, or a soldered terminal) which is widely used for connection in electrical and electronic products, a semiconductor product, an automobile, or the like. More specifically, the present invention relates to a terminal specifically suited for a use in which solderability, contact reliability and the like are required, to a part having the same (for example, a connector, a relay, a slide switch, a resistance, a capacitor, a coil, or a substrate), and to a product having the same (for example, a semiconductor product, an electrical product, an electronic product, a solar battery, or an automobile).

2. Description of the Background Art

Means for conducting electricity in various products such as a semiconductor product, an electrical product, an electronic product, a solar battery, and an automobile can be a method of soldering or contacting using a terminal formed with a conductive base.

As disclosed in Japanese Patent Laying-Open No. 1-298617, for example, a surface of such terminal is usually covered with a metal such as Au, Ag, Pd, Cu, Ni, In, Sn, or an Sn—Pb alloy to improve solderability or corrosion resistance of a surface of the conductive base. Among these metals, Sn or the Sn—Pb alloy is most generally used in consideration of a cost and the like, and an electroplating method is usually adopted as a method of covering.

When the electroplating is performed with Sn alone, however, a large columnar single crystal is generated in such a surface cover layer, which promotes generation of a whisker. Since generation of the whisker causes an electrical short circuit, the generation is required to be prevented.

As means for preventing the generation of the whisker, alloying of Sn, that is, use of an Sn—Pb alloy or the like has been conventionally attempted. Since Pb is a toxic metal as is well-known, however, use thereof is limited due to consideration to an environment.

Therefore, attempts have been made to develop methods of forming various Sn-based alloys as substitutes for the Sn—Pb alloy with electroplating. Regarding an Sn—Cu alloy, for example, though it has a minimum melting point (227° C.) and shows good solderability with 99.3 mass % of Sn and 0.7 mass % of Cu, generation of the whisker (columnar crystal) cannot be effectively prevented because of a small content of Cu. In contrast, if the content of Cu is increased, the melting point is significantly increased and thus the solderability is deteriorated.

As described above, formation of the Sn-based alloy which prevents the generation of whisker and, at the same time, attains good solderability (that is, a low melting point) with electroplating is not known.

The Sn-based alloy is sometimes used in melting solder such as solder dip or cream solder merely for adhering the terminal as mentioned above. As such Sn-based alloy, an alloy formed of Sn, Ag and Cu is sometimes used.

As disclosed in, for example, Japanese Patent Laying-Open No. 5-50286, however, the Sn-based alloy for such use only shows an adhesion property by mere heat melting (melting solder) of each metal of Sn, Ag and Cu (or an ingot obtained by melting and mixing these metals), and since an application thickness thereof cannot be controlled, uniform coating with a small thickness of at most 100 μm on the terminal is not possible.

When the uniform coating with the small thickness as such is not possible, stability of an exterior property is not obtained and, in addition, an electrical short circuit is caused. Furthermore, a pinhole or the like is easily generated and corrosion resistance is deteriorated.

Japanese Patent Laying-Open No. 2001-164396 discloses a terminal such as a connector which is plated with a stannum-silver-copper ternary alloy. In this publication, however, as a state of a crystal or a melting point of a layer formed with the stannum-silver-copper ternary alloy plating is not examined in detail, generation of the whisker cannot be sufficiently prevented with a method disclosed in this publication, and it is also not possible to obtain good solderability. In addition, the method disclosed in this publication is characterized in that a plating bath contains a specific sulfur compound to prevent a copper compound in the plating bath from depositing on a stannum electrode. A concentration of the sulfur compound, however, must be increased to increase a concentration of the copper compound in the plating bath, which may destroy a balance of components in the plating bath. Therefore, the copper compound of a high concentration cannot be used in the plating bath and since a concentration of copper in a stannum-silver-copper ternary alloy plating film cannot be increased, the plating film having a low melting point cannot be obtained.

In Japanese Patent Laying-Open No. 2001-26898, there is a vague description about stannum-silver-copper ternary alloy plating using water-soluble silver salt together with water-soluble stannum salt and water-soluble copper salt. In this publication, however, as a state of a crystal or a melting point of a layer formed with the stannum-silver-copper ternary alloy plating is also not examined in detail, generation of the whisker cannot be sufficiently prevented with a method disclosed in this publication, and it is also not possible to obtain good solderability.

### SUMMARY OF THE INVENTION

The present invention is made in view of such present circumstances. An object of the present invention is to provide a terminal formed with a conductive base which attains prevention of generation of a whisker concomitant with good solderability and which has a surface layer of a small and uniform thickness.

A terminal according to the present invention is characterized in that, a surface layer formed of an Sn—Ag—Cu ternary alloy is formed with electroplating on a whole surface or a portion of a conductive base.

The Sn—Ag—Cu ternary alloy is constructed with a ratio of 70-99.8 mass % of Sn, 0.1-15 mass % of Ag and 0.1-15 mass % of Cu, has a melting point of 210-230° C., and is formed in a state of a crystal of a minute particle as compared with the surface layer formed of Sn alone.

The terminal can be any of a connector terminal, a relay terminal, a slide switch terminal, and a soldered terminal.

A part according to the present invention is a part having the terminal described above, and can be any of a connector, a relay, a slide switch, a resistance, a capacitor, a coil, and a substrate.

A product according to the present invention is a product having the terminal described above, and can be any of a semiconductor product, an electrical product, an electronic product, a solar battery, and an automobile.

The surface layer is preferably formed in a condition of coexistence of at least two chelating agents and, more preferably, the chelating agents include at least an inorganic chelating agent and an organic chelating agent.

A method of manufacturing the terminal according to the present invention includes the step of forming the surface layer formed of the Sn—Ag—Cu ternary alloy with electroplating on a whole surface or a portion of the conductive base, and the step is preferably performed in a condition of coexistence of at least two chelating agents.

The chelating agents preferably include at least an inorganic chelating agent and an organic chelating agent.

As the terminal according to the present invention has a construction as described above, in particular, as the surface layer formed of the Sn—Ag—Cu ternary alloy is formed with electroplating on a whole surface or a portion of the conductive base, prevention of generation of the whisker concomitant with good solderability can be attained, and the surface layer can be made to have a small and uniform thickness.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a photomicrograph of a cross section of a surface layer formed of an Sn—Ag—Cu ternary alloy.

FIG. 2 is a photomicrograph of a cross section of a surface layer formed of Sn alone.

### DESCRIPTION OF THE PREFERRED EMBODIMENTS

Terminal

A terminal according to the present invention is characterized in that, a surface layer formed of an Sn—Ag—Cu ternary alloy is formed with electroplating on a whole surface or a portion of a conductive base.

The terminal as such includes a terminal which is brought into electrical conduction by, for example, soldering or contact, so that a part or a product described below can perform an intended function. In addition, the terminal can be suitably used for a purpose for which high corrosion resistance or stability of an exterior property is required.

Specific examples of the terminal include a connector terminal, a relay terminal, a slide switch terminal, and a soldered terminal, while a use thereof can be, for example, a terminal of a resistance, a capacitor or a coil.

Examples of the terminal further include a circuit (interconnection portion) of a circuit board, a bump and a via, as well as a flat cable, an electric wire and a lead portion of a solar battery.

Conductive Base

As the conductive base forming the terminal according to the present invention, any conventionally known conductive base used for electrical and electronic products, a semiconductor product, an automobile, or the like can be used.

As an example, the conductive base of the present invention includes any conductive base provided that it has, at least on a surface thereof, a material based on a copper alloy such as copper (Cu), phosphor bronze, brass, beryllium copper, titanium copper, or nickel silver (Cu, Ni, Zn), a material based on an iron alloy such as iron (Fe), an Fe—Ni alloy or stainless steel, other metal such as a nickel-based material, or the like. Therefore, a copper pattern on any kind of substrate, for example, is also included. Thus, a suitable example of the conductive base of the present invention includes any kind of metal, or an insulation base formed of a polymer film, ceramic, or the like, having a metal layer (that is, any kind of circuit pattern) formed thereon.

Furthermore, the conductive base as described above which has an Sn layer formed on a whole surface or a portion thereof can be suitable as the conductive base of the present invention. When the conductive base as such is used, the surface layer formed of the Sn—Ag—Cu ternary alloy will be formed at least on a whole surface or a portion of the Sn layer.

A merit in using a base material having the Sn layer formed on a whole surface or a portion of the conductive base as described above is that, from a viewpoint of attaining prevention of generation of a whisker and a low melting point, an effect similar to that obtained with an Sn—Ag—Cu ternary alloy thin film of the present invention directly formed on the conductive base is obtained at a low cost. This is because amounts of Sn, Ag and Cu compounds used to form the surface layer formed of the Sn—Ag—Cu ternary alloy according to the present invention, which compounds are relatively expensive, can be substantially decreased. Therefore, use of the base material having the Sn layer formed thereon is particularly advantageous when the surface layer formed of the Sn—Ag—Cu ternary alloy is required to be formed on a large area, or when the surface layer formed of the Sn—Ag—Cu ternary alloy is required to be formed with a large thickness.

The Sn layer as such is preferably formed on the conductive base with electroplating, and the electroplating using Sn as an anode is especially advantageous regarding the cost. The Sn layer as such can be usually formed on the conductive base with a thickness of 0.1-80 μm.

It is to be noted that, a form of the conductive base is not limited to a two-dimensional form such as a tape-like form, and a three-dimensional form such as a press-molded product or any other form can be included.

Surface Layer

The surface layer according to the present invention is formed with electroplating on a whole surface or a portion of the conductive base, and is formed of an Sn—Ag—Cu ternary alloy.

The Sn—Ag—Cu ternary alloy is formed only of three metals of Sn, Ag and Cu, except for mixing of a trace amount of an unavoidable impurity. In the Sn—Ag—Cu ternary alloy, a composition ratio of Sn is preferably 70-99.8 mass %, more preferably, no more than 97 mass %, further preferably 95 mass %, and no less than 80 mass %, further preferably 90 mass %. When the composition ratio of Sn is less than 70 mass %, a melting point becomes excessively high and good solderability may not be obtained. When the composition ratio of Sn is more than 99.8 mass %, a whisker is markedly generated.

In addition, a composition ratio of Ag is preferably 0.1-15 mass %, more preferably, no more than 12 mass %, further preferably 8 mass %, and no less than 0.5 mass %, further preferably 1 mass %. When the composition ratio of Ag is less than 0.1 mass %, the whisker is markedly generated. When the composition ratio of Ag is more than 15 mass %, the melting point becomes excessively high and good solderability may not be obtained.

In addition, a composition ratio of Cu is preferably 0.1-15 mass %, more preferably, no more than 12 mass %, further preferably 8 mass %, and no less than 0.5 mass %, further preferably 1 mass %. When the composition ratio of Cu is less than 0.1 mass %, the whisker is markedly generated. When the composition ratio of Cu is more than 15 mass %, the melting point becomes excessively high and good solderability may not be obtained.

With the composition ratio as described above, the Sn—Ag—Cu ternary alloy preferably has the melting point of 200-260° C., more preferably, no more than 240° C., further preferably 230° C., and no less than 210° C., further preferably 215° C. With the melting point within a range as described above, good solderability is obtained. The melting point of 210-230° C. is especially preferable.

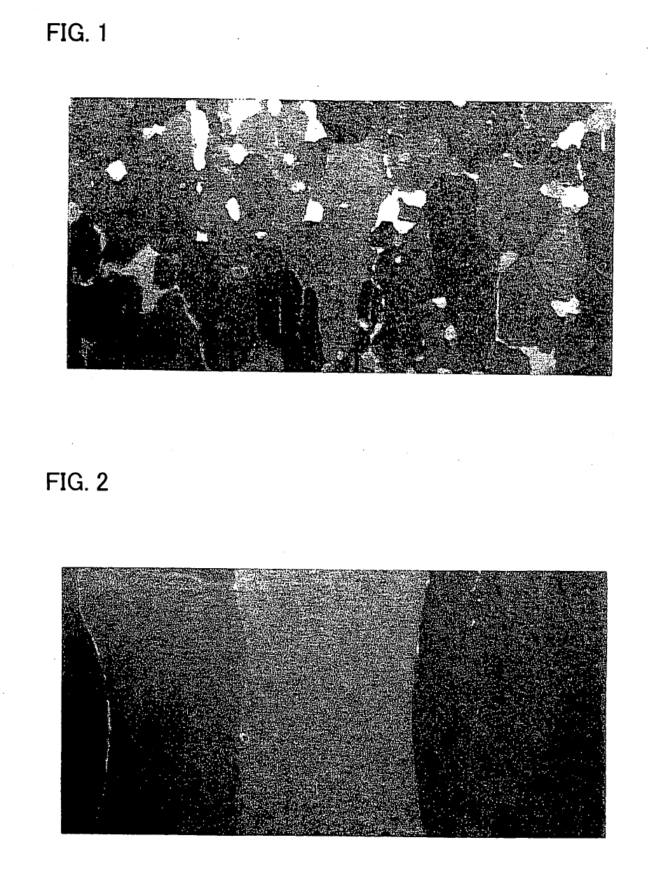

By forming the surface layer with the Sn—Ag—Cu ternary alloy as such, prevention of generation of the whisker concomitant with good solderability (that is, a low melting point) are attained. In particular, as is obvious from a comparison between FIGS. 1 and 2, while many minute crystals exist in FIG. 1, which is a photomicrograph of a cross section, obtained using an FIB (Focused Ion Beam) apparatus, of the surface layer formed of the Sn—Ag—Cu ternary alloy with electroplating, a large columnar crystal causing generation of the whisker exists in FIG. 2, which is a photomicrograph of a cross section of the surface layer formed of Sn alone with electroplating.

Furthermore, as the surface layer is formed with electroplating, a thickness thereof can be made small and uniform, and hardness thereof can be controlled freely. In addition, the Sn—Ag—Cu ternary alloy having such a minute crystal particle form as shown in FIG. 1 cannot be formed when the surface layer is formed with a method other than electroplating.

When the surface layer is formed with minute crystal particles as in the present application, any kind of additive present in a gap between the crystal particles acts as an impurity to the crystal particles, and the solderability is further enhanced because of melting at a lower temperature during soldering.

In contrast, when the surface layer formed of the Sn—Ag—Cu ternary alloy is formed with melting solder or reflow rather than electroplating, an inner structure thereof is formed in a massive form rather than the minute crystal particle form, and thus the good solderability cannot be expected. Furthermore, as it is difficult to control the thickness of the surface layer, the surface layer having the small and uniform thickness cannot be formed, resulting in generation of an electrical short circuit or a pinhole. In addition, when the conductive base has a complicated form, the surface layer cannot be formed uniformly throughout a whole surface of the conductive base, which may result in formation of a massive form including the whole conductive base.

All drawbacks as described above can be resolved by forming the surface layer with electroplating as in the present application.

Method of Manufacturing Terminal

A method of manufacturing the terminal according to the present invention includes the step of forming the surface layer formed of the Sn—Ag—Cu ternary alloy with electroplating on a whole surface or a portion of the conductive base, and is characterized in that the step is performed in a condition of coexistence of at least two chelating agents.

The method of manufacturing the terminal of the present invention can include a pretreatment step, a step of forming a ground layer or the like in addition to the aforementioned step. More specific description will now be given in the following.

Pretreatment Step

In the method of manufacturing the terminal of the present invention, the pretreatment step for pretreatment of the conductive base can be included prior to the step of forming the surface layer formed of the Sn—Ag—Cu ternary alloy with electroplating on a whole surface or a portion of the conductive base.

The pretreatment step is performed to form the surface layer stably with high adhesion and without generation of the pinhole. The pretreatment step is particularly effective when the conductive base is formed of a rolled metal such as phosphor bronze.

That is, the pretreatment step as such can be performed by allowing an acid having a pH of at most 5 to act on at least a portion of the conductive base on which the surface layer is to be formed (acid treatment). In addition, the pretreatment step of the present invention preferably includes a step of first washing in which the conductive base is immersed in an aqueous solution, a step of second washing in which the conductive base is electrolyzed in an aqueous solution, and a step of acid treatment in which the acid having a pH of at most 5 is allowed to act on the conductive base.

More specifically, the step of first washing is performed by immersing the conductive base in a bath filled with the aqueous solution, and washing with water is repeated for several times.

The aqueous solution in the step of first washing preferably has a pH of at least 0.01, and treatment in an alkaline condition with a pH of at least 9 is more preferable. A specific range of the pH is at most 13.8, further preferably 13.5, and at least 9.5, further preferably 10. The pH lower than 0.01 or higher than 13.8 is not preferable because a surface of the conductive base will be excessively roughened or deteriorated.

An alkali used is not specifically limited as long as a pH within the range described above is obtained. Wide-ranging substances such as sodium hydroxide, potassium hydroxide, calcium hydroxide, a chelating agent, and a surface-active agent can be used. In addition, a temperature of the aqueous solution in the step of first washing is 20-90° C., preferably 40-60° C.

Thereafter, the step of second washing is performed by electrolyzing in the aqueous solution using the conductive base as an electrode, and washing with water is again repeated for several times. With this step, gas is produced on the surface of the conductive base, and contamination of the surface of the conductive base is removed more efficiently by an oxidation-reduction action with the gas and a physical action with bubbles of the gas.

The aqueous solution in the step of second washing preferably has a pH of at least 0.01, and treatment in an alkaline condition with a pH of at least 9 is more preferable. A specific range of the pH is at most 13.8, further preferably 13.5, and at least 9.5, further preferably 10. The pH lower than 0.01 or higher than 13.8 is not preferable because the surface of the conductive base will be excessively roughened or deteriorated.

An alkali used is not specifically limited as long as a pH within the range described above is obtained. Wide-ranging substances such as sodium hydroxide, potassium hydroxide, calcium hydroxide, a chelating agent, and a surface-active agent can be used.

In addition, conditions of electrolysis described above can be a solution temperature of 20-90° C., preferably 30-60° C., a current density of 0.1-20 A/dm², preferably 2-8 A/dm², and an electrolysis time of 0.1-5 minutes, preferably 0.5-2 minutes. The conductive base can be made as either an anode or a cathode, and it is also possible to switch between the anode and cathode successively during the step.

Thereafter, acid treatment (activation treatment) can be performed by immersing the conductive base in a bath containing an acid such as sulfuric acid, hydrochloric acid, ammonium persulfate, or hydrogen peroxide to allow the acid to act on the surface of the conductive base.

The acid preferably has a pH of at most 6, more preferably 4.5, further preferably 3, and at least 0.001, further preferably 0.1. Activation cannot be sufficiently performed when the pH is higher than 6, while the surface of the conductive base will be excessively roughened or deteriorated when the pH is lower than 0.001, and thus such conditions are not preferable.

In addition, an immersion time for immersing the conductive base in the bath containing the acid is preferably 0.1-10 minutes, more preferably at most 5 minutes, further preferably 3 minutes, and at least 0.5 minutes, further preferably 1 minute. Activation cannot be sufficiently performed when the immersion time is shorter than 0.1 minutes, while the surface of the conductive base will be excessively roughened or deteriorated when the immersion time is longer than 10 minutes, and thus such conditions are not preferable.

When the conductive base is formed by forming a copper layer formed of copper or a copper alloy in a circuit form on a polymer film, only the treatment with the acid (acid treatment) can be performed without performing the steps of first and second washing as described above. This is for preventing the polymer film from being deteriorated by washing with the alkali. In this situation, similar conditions as described above can be adopted for the treatment with the acid (acid treatment).

By performing the pretreatment to the surface of the conductive base as described above, the surface layer can be formed on the conductive base without generation of the pinhole and with uniform and strong adhesion.

Step of Forming, Ground Layer

In the method of manufacturing the terminal of the present invention, the step of forming the ground layer can be performed subsequent to the above-described pretreatment step. The step of forming the ground layer is effective when the conductive base is made of a material such as SUS or iron, which has low adhesion to the surface layer. In the present invention, a description such as “the surface layer is formed on a whole surface or a portion of the conductive base” is given even when the ground layer is formed as such and, in this respect, the ground layer can be regarded as the conductive base itself as long as the ground layer is formed of a metal.

When the conductive base is SUS, for example, the ground layer as such can be formed by electroplating with Ni to a thickness of 0.1-5 μm, preferably 0.5-3 μm. When the conductive base is brass, the ground layer can be formed by electroplating with Ni or Cu to a similar thickness as above.

Formation of the ground layer as such is effective especially when the conductive base is made of brass in preventing Zn included in brass from diffusing into the surface layer and suppressing the solderability.

Step of Forming Surface Layer

The surface layer formed of the Sn—Ag—Cu ternary alloy can be formed with electroplating for a whole surface or a portion of the conductive base, directly or after the pretreatment step and/or the step of forming the ground layer as described above.

The surface layer is preferably formed with a thickness of 0.1-100 μm, more preferably at most 12 μm, further preferably 8 μm, and at least 0.5 μm, further preferably 1.5 μm.

Conditions of the electroplating described above can be such that, using a plating solution (including 5-90 g/l, preferably 20-60 g/l of the metal Sn of an Sn compound; 0.1-10 g/l, preferably 0.5-5 g/l of the metal Ag of an Ag compound; 0.1-5 g/l, preferably 0.5-3 g/l of the metal Cu of a Cu compound; 50-200 g/l, preferably 80-130 g/l of an organic acid; 2-50 g/l, preferably 5-30 g/l of an inorganic chelating agent; 2-50 g/l, preferably 5-30 g/l of an organic chelating agent; and a small amount of other additive), a solution temperature of 10-80° C., preferably 20-40° C., and a current density of 0.1-30 A/dm², preferably 2-25 A/dm².

The above-described Sn compound is a compound including at least Sn, which can be, for example, stannous oxide, stannous sulfate, or stannum salt of any kind of organic acid. The above-described Ag compound is a compound including at least Ag, which can be, for example, silver oxide or silver salt of any kind of organic acid. The above-described Cu compound is a compound including at least Cu, which can be, for example, copper sulfate, copper chloride, or copper salt of any kind of organic acid.

It is particularly preferable that the Sn, Ag and Cu compounds be soluble salts respectively containing a common anion as a counterion. With this, together with combined use of inorganic and organic chelating agents, isolation and precipitation of Ag and Cu out of a plating bath can be suppressed highly effectively. The anion as such can be, for example, an anion derived from an inorganic acid, such as a sulfate ion, a nitrate ion, a phosphate ion, a chloride ion, or a hydrofluoric acid ion, or an anion derived from an organic acid such as methanesulfonic acid, ethanesulfonic acid, propanesulfonic acid, benzenesulfonic acid, phenylsulfonic acid, alkylarylsulfonic acid, alkanolsulfonic acid, formic acid, acetic acid, propionic acid, butyric acid, benzoic acid, phthalic acid, oxalic acid, adipic acid, lactic acid, citric acid, malonic acid, succinic acid, tartaric acid, or malic acid, such as a methanesulfonate anion or an ethanesulfonate anion.

In addition, as described above, the step of forming the surface layer is performed in a condition of coexistence of at least two chelating agents. This is because, without using the chelating agents, Ag and Cu are isolated and precipitated out of the plating solution, and it becomes difficult to form the Sn—Ag—Cu ternary alloy having a desired composition ratio with electroplating as the surface layer.

In addition, at least two chelating agents are used because a kind of a chelating agent suitable for preventing isolation and precipitation of Ag is different from a kind of a chelating agent suitable for preventing isolation and precipitation of Cu.

That is, the chelating agent suitable for preventing isolation and precipitation of Ag can be an inorganic chelating agent, while the chelating agent suitable for preventing isolation and precipitation of Cu can be an organic chelating agent.

The above-described inorganic chelating agent is a chelating agent made from an inorganic compound, which can be, for example, a polymer phosphate-based chelating agent, a condensed phosphate-based chelating agent, an aluminum salt-based chelating agent, a manganese salt-based chelating agent, a magnesium salt-based chelating agent, or a metal fluoro complex-based chelating agent (for example, (TiF²⁻)OH or (SiF²⁻)OH).

In addition, the organic chelating agent is a chelating agent made from an organic compound, which can be, for example, nitrilotriacetic acid, ethylenediaminetetraacetic acid, diethylenetriaminepentaacetic acid, hydroxyethylenediaminetriacetic acid, dipivaloylmethanate, lauryldiacetic acid, a kind of porphyrin, or a kind of phthalocyanine.

It was found out that isolation and precipitation of Ag and Cu can be steadily and effectively suppressed when the inorganic chelating agent was mixed with a ratio of no less than 1 part by mass and no more than 300 parts by mass to 1 part by mass of Ag of the Ag compound, and the organic chelating agent was mixed with a ratio of no less than 1 part by mass and no more than 200 parts by mass to 1 part by mass of Cu of the Cu compound. Ag is isolated and precipitated when the ratio of the inorganic chelating agent is less than 1 part by mass, and when the ratio is more than 300 parts by mass, a balance of the plating bath itself may be destroyed and the organic chelating agent or the like may be aggregated and precipitated. On the other hand, Cu is isolated and precipitated when the ratio of the organic chelating agent is less than 1 part by mass, and when the ratio is more than 200 parts by mass, a balance of the plating bath itself may be destroyed and the inorganic chelating agent or the like may be aggregated and precipitated.

The ratio of the inorganic chelating agent to Ag is preferably no more than 200 parts by mass, more preferably 150 parts by mass, and no less than 3 parts by mass, more preferably 4 parts by mass. The ratio of the organic chelating agent to Cu is preferably no more than 150 parts by mass, more preferably 130 parts by mass, and no less than 2 parts by mass, more preferably 3 parts by mass.

As described above, the method of manufacturing the terminal according to the present invention includes the step of forming the surface layer formed of the Sn—Ag—Cu ternary alloy with electroplating on a whole surface or a portion of the conductive base, and the step is performed in the condition of coexistence of at least two chelating agents. The method is characterized in that the chelating agents include at least the inorganic chelating agent and the organic chelating agent.

With this, isolation and precipitation of Ag or Cu in the plating bath can be highly effectively suppressed and, at the same time, as the plating bath does not contain a sulfur compound as that described in the aforementioned Japanese Patent Laying-Open No. 2001-164396, the plating bath can contain a copper compound or a silver compound of a high concentration. As a result, a concentration of copper or silver in the surface layer formed of the Sn—Ag—Cu ternary alloy can be easily increased, and thus the surface layer having the extremely low melting point of 210-230° C. can be provided.

The plating bath of the present invention can include any kind of additive in addition to each compound described above. Any conventionally known additive such as polyethylene glycol, polyoxyalkylenenaphthol, an aromatic carbonyl compound, an aromatic sulfonic acid, or a glue can be used as the additive without specific limitation.

In the plating bath, it is preferable to use Sn, an Sn alloy or an insoluble plate as an anode, and use of the insoluble plate is especially preferable. This is because isolation and precipitation of Ag and Cu out of the plating bath, particularly a phenomenon of substitution for the anode can be suppressed highly effectively by using the insoluble plate, together with combined use of the inorganic and organic chelating agents as described above. As a result, the plating bath can contain the Ag compound and the Cu compound of high concentrations, and thus Ag and Cu contents in the surface layer formed of the Sn—Ag—Cu ternary alloy can be increased, resulting in attaining prevention of generation of the whisker concomitant with good solderability (a low melting point) highly effectively.

The insoluble plate described here is a plate obtained by coating a surface of an electrode formed of Ti with, for example, Pt, Ir, Ru, Rh, or two or more of these substances. A specifically suitable example is the electrode formed of Ti having the surface coated with Pt, because the phenomenon of substitution can be suppressed more effectively by using such insoluble plate.

Though a plating apparatus used for the above-described electroplating is not specifically limited, it is preferable to use, for example, a barrel plating apparatus, a rack plating apparatus or a continuous plating apparatus. The terminal of the present invention can be manufactured with extremely high efficiency using any of these apparatus.

The barrel plating apparatus is an apparatus for plating terminals separately on a one-by-one basis, while the continuous plating apparatus is an apparatus for continuously plating a plurality of terminals at a time. The rack plating apparatus is positioned between the aforementioned two apparatus, and has a medium scale manufacturing efficiency. These apparatus are well-known in a plating industry, and any of the apparatus can be used as long as a structure thereof is known.

Part

The part according to the present invention is a part having the terminal described above. Examples can include an electrical part, an electronic part, a semiconductor part, a solar battery part, and an automobile part which are used as a connector, a relay, a slide switch, a resistance, a capacitor, a coil, a substrate, or the like. The part, however, is not limited to these parts or to a specific form thereof.

Product

The product according to the present invention is a product having the terminal described above. Though examples can include a semiconductor product, an electrical product, an electronic product, a solar battery, and an automobile, the product is not limited to these products.

### EXAMPLES

Though the present invention will be described in detail with examples, the present invention is not limited to these examples.

### Example 1

Phosphor bronze in a tape-like form as the conductive base, which was rolled to have a thickness of 0.3 mm and a width of 30 mm and then pressed to have a form of a connector to be a continuous form of connector terminals, was cut to have a length of 100 m and taken up on a reel. The reel was then set on a feeding-out shaft of the continuous plating apparatus.

Then, the step of first washing was performed by continuously immersing the conductive base for 1 minute in an immersion bath of the continuous plating apparatus which was filled with an aqueous solution containing sodium hydroxide (using 50 g/l of Ace Clean 30 (produced by Okuno Chemical Industries Co., Ltd.), pH 12.5) at a solution temperature of 48° C. Thereafter, washing with water was performed for several times.

Thereafter, the step of second washing was performed by electrolyzing in an electrolytic bath of the continuous plating apparatus having an alkaline pH (using 100 g/l of NC Rustol (produced by Okuno Chemical Industries Co., Ltd.) as the aqueous solution of sodium hydroxide, pH 13.2) using the conductive base subjected to the first washing as a cathode at a solution temperature of 50° C. with a current density of 5 A/dm² for 1 minute, and then washing with water was again repeated for 5 times.

Then, the acid treatment with the acid for allowing the acid to act on the surface of the conductive base was performed by immersing the conductive base washed as such in an activation bath filled with sulfuric acid having a pH of 0.5 at a solution temperature of 30° C. for 1 minute. Thereafter, washing with water was repeated for 3 times.

Next, the step of forming the ground layer was performed to form the ground layer formed of Ni to the conductive base processed as described above. That is, a plating bath of the continuous plating apparatus was filled with an Ni plating solution (containing 240 g/l of nickel sulfate, 45 g/l of nickel chloride and 40 g/l of boric acid), and electroplating in a condition of a solution temperature of 55° C., pH 3.8 and a current density of 4 A/dm² was performed for 5 minutes to form the ground layer formed of Ni. Thereafter, washing with water was repeated for 3 times.

Subsequently, the step of forming the surface layer formed of the Sn—Ag—Cu ternary alloy was performed by electroplating for the conductive base having the ground layer formed thereon as described above. That is, the conductive base having the ground layer formed thereon was used as a cathode while the electrode formed of Ti having the surface coated with Pt was used as an anode, and a plating bath of the continuous plating apparatus was filled with an Sn—Ag—Cu ternary alloy plating solution (containing 110 g/l of methanesulfonic acid, trade name: Metasu AM (produced by Yuken Industry Co., Ltd), 60 g/l of Sn, 3 g/l of Ag, 2 g/l of Cu, 15 g/l of an inorganic chelating agent (potassium polyphosphate (KH)ₙ₊₂PₙO₃ₙ₊₁ (molecular weight: 57.1+80n, n=5-11), trade name: FCM-A, produced by FCM Co., Ltd.), 10 g/l of an organic chelating agent (tetranaphthyl porphyrin, trade name: FCM-B, produced by FCM Co., Ltd.), and 30 cc/l of an additive (polyethylene glycol, trade name: FCM-C, produced by FCM Co., Ltd., though the additive can be arbitrarily replaced with a known additive (for example, polyoxyalkylenenaphthol, an aromatic carbonyl compound, an aromatic sulfonic acid, or a glue))) to perform electroplating in a condition of a solution temperature of 35° C., pH 0.5 and a current density of 8 A/dm² for 2 minutes to form the surface layer formed of the Sn—Ag—Cu ternary alloy. Thereafter, washing with water was performed for 4 times, and drip-drying with air and drying with hot air of 70° C. for 2 minutes were performed to obtain the terminal of the present invention.

For the terminal obtained as such, samples were taken at points of 10 m and 90 m from an end thereof, and cross sections thereof were cut using the FIB apparatus to measure thicknesses thereof. As a result, the ground layer formed of Ni had a thickness of 1.1 μm, while the surface layer formed of the Sn—Ag—Cu ternary alloy had a thickness of 3.5 μm. Furthermore, the surface layer was extremely uniform (in a state of a crystal of a minute particle).

In addition, an alloy ratio of the surface layer measured using an EPMA was 93 mass % of Sn, 4.2 mass % of Ag and 2.8 mass % of Cu. A melting point of this surface layer was 227° C. and thus good solderability was shown.

Furthermore, generation of a whisker was not observed when the terminal was kept in a high temperature and high humidity bath (60° C., 90% humidity) for 2000 hours. That is, the terminal which attains prevention of generation of the whisker concomitant with good solderability (that is, the low melting point) could be obtained.

### Example 2

The terminal according to the present invention was obtained as described in example 1 except that, in place of the Sn—Ag—Cu ternary alloy plating solution used in example 1, an Sn—Ag—Cu ternary alloy plating solution (containing 110 g/l of the aforementioned Metasu AM (produced by Yuken Industry Co., Ltd), 60 g/l of Sn, 3.4 g/l of Ag, 1.2 g/l of Cu, 15 g/l of the inorganic chelating agent (the aforementioned FCM-A, produced by FCM Co., Ltd.), 10 g/l of the organic chelating agent (the aforementioned FCM-B, produced by FCM Co., Ltd.), and 30 cc/l of the additive (the aforementioned FCM-C, produced by FCM Co., Ltd.)) was used.

For the terminal obtained as such, samples were taken at points of 10 m and 90 m from an end thereof, and cross sections thereof were cut using the FIB apparatus to measure thicknesses thereof. As a result, the ground layer formed of Ni had a thickness of 1.1 μm, while the surface layer formed of the Sn—Ag—Cu ternary alloy had a thickness of 3.5 μm. Furthermore, the surface layer was extremely uniform (in a state of a crystal of a minute particle).

In addition, an alloy ratio of the surface layer measured using the EPMA was 93.6 mass % of Sn, 4.7 mass % of Ag and 1.7 mass % of Cu. A melting point of this surface layer was 217° C. and thus good solderability was shown.

Furthermore, generation of the whisker was not observed when the terminal was kept in the high temperature and high humidity bath (60° C., 90% humidity) for 2000 hours. That is, the terminal which attains prevention of generation of the whisker concomitant with good solderability (that is, the low melting point) could be obtained.

### Example 3

The terminal according to the present invention was obtained as described in example 1 except that, in place of the Sn—Ag—Cu ternary alloy plating solution used in example 1, an Sn—Ag—Cu ternary alloy plating solution (containing 110 g/l of the aforementioned Metasu AM (produced by Yuken Industry Co., Ltd), 60 g/l of Sn, 3.8 g/l of Ag, 1.2 g/l of Cu, 15 g/l of the inorganic chelating agent (the aforementioned FCM-A, produced by FCM Co., Ltd.), 10 g/l of the organic chelating agent (the aforementioned FCM-B, produced by FCM Co., Ltd.), and 30 cc/l of the additive (the aforementioned FCM-C, produced by FCM Co., Ltd.)) was used.

For the terminal obtained as such, samples were taken at points of 10 m and 90 m from an end thereof, and cross sections thereof were cut using the FIB apparatus to measure thicknesses thereof. As a result, the ground layer formed of Ni had a thickness of 1.1 μm, while the surface layer formed of the Sn—Ag—Cu ternary alloy had a thickness of 3.5 μm. Furthermore, the surface layer was extremely uniform (in a state of a crystal of a minute particle).

In addition, an alloy ratio of the surface layer measured using the EPMA was 93 mass % of Sn, 5.3 mass % of Ag and 1.7 mass % of Cu. A melting point of this surface layer was 228° C. and thus good solderability was shown.

Furthermore, generation of the whisker was not observed when the terminal was kept in the high temperature and high humidity bath (60° C., 90% humidity) for 2000 hours. That is, the terminal which attains prevention of generation of the whisker concomitant with good solderability (that is, the low melting point) could be obtained.

### Comparative Example 1

A terminal was obtained as described in example 1 except that, in place of the Sn—Ag—Cu ternary alloy plating solution used in example 1, an Sn—Ag binary alloy plating solution (containing 110 g/l of the aforementioned Metasu AM (produced by Yuken Industry Co., Ltd), 60 g/l of Sn, 3.3 μl of Ag, 15 μl of the inorganic chelating agent (the aforementioned FCM-A, produced by FCM Co., Ltd.), and 30 cc/I of the additive (the aforementioned FCM-C, produced by FCM Co., Ltd.)) was used.

For the terminal obtained as such, samples were taken at points of 10 m and 90 m from an end thereof, and cross sections thereof were cut using the FIB apparatus to measure thicknesses thereof. As a result, the ground layer formed of Ni had a thickness of 1.1 μm, while a surface layer formed of the Sn—Ag binary alloy had a thickness of 3.5 μm.

In addition, an alloy ratio of the surface layer measured using the EPMA was 96.0 mass % of Sn and 4.0 mass % of Ag. A melting point of this surface layer was 227° C.

Though the surface layer of this terminal had the same melting point as the surface layer of the terminal of example 1, the whisker was generated when it was kept in the high temperature and high humidity bath (60° C., 90% humidity) for 2000 hours. That is, in the terminal using such binary alloy for the surface layer, the whisker was generated when the melting point of the surface layer was decreased. Therefore, prevention of generation of the whisker could not be attained concomitantly with good solderability (that is, the low melting point).

### Comparative Example 2

A terminal was obtained as described in example 1 except that, in place of the Sn—Ag—Cu ternary alloy plating solution used in example 1, an Sn—Cu binary alloy plating solution (containing 110 g/l of the aforementioned Metasu AM (produced by Yuken Industry Co., Ltd), 60 g/l of Sn, 0.7 g/l of Cu, 10 g/l of the organic chelating agent (the aforementioned FCM-B, produced by FCM Co., Ltd.), and 30 cc/l of the additive (the aforementioned FCM-C, produced by FCM Co., Ltd.)) was used.

For the terminal obtained as such, samples were taken at points of 10 m and 90 m from an end thereof, and cross sections thereof were cut using the FIB apparatus to measure thicknesses thereof. As a result, the ground layer formed of Ni had a thickness of 1.1 μm, while a surface layer formed of the Sn—Cu binary alloy had a thickness of 3.5 μm.

In addition, an alloy ratio of the surface layer measured using the EPMA was 99.3 mass % of Sn and 0.7 mass % of Cu. A melting point of this surface layer was 227° C.

Though the surface layer of this terminal had the same melting point as the surface layer of the terminal of example 1, the whisker was generated when it was kept in the high temperature and high humidity bath (60° C., 90% humidity) for 300 hours. That is, in the terminal using such binary alloy for the surface layer, the whisker was generated when the melting point of the surface layer was decreased. Therefore, prevention of generation of the whisker could not be attained concomitantly with good solderability (that is, the low melting point).

### Comparative Example 3

A terminal was obtained as described in example 1 except that, in place of the Sn—Ag—Cu ternary alloy plating solution used in example 1, an Sn—Ag binary alloy plating solution (containing 110 g/l of the aforementioned Metasu AM (produced by Yuken Industry Co., Ltd), 60 g/l of Sn, 6.0 g/l of Ag, 20 g/l of the inorganic chelating agent (the aforementioned FCM-A, produced by FCM Co., Ltd.), and 30 cc/l of the additive (the aforementioned FCM-C, produced by FCM Co., Ltd.)) was used.

For the terminal obtained as such, samples were taken at points of 10 m and 90 m from an end thereof, and cross sections thereof were cut using the FIB apparatus to measure thicknesses thereof. As a result, the ground layer formed of Ni had a thickness of 1.1 μm, while a surface layer formed of the Sn—Ag binary alloy had a thickness of 3.5 μm.

In addition, an alloy ratio of the surface layer measured using the EPMA was 93.6 mass % of Sn and 6.4 mass % of Ag. A melting point of this surface layer was 257° C.

Though the surface layer of the terminal had the same Sn content as the surface layer of the terminal of example 2, the melting point thereof was increased by 40° C., and thus it had inferior solderability.

### Comparative Example 4

A terminal was obtained as described in example 1 except that, in place of the Sn—Ag—Cu ternary alloy plating solution used in example 1, an Sn—Cu binary alloy plating solution (containing 110 g/l of the aforementioned Metasu AM (produced by Yuken Industry Co., Ltd), 60 g/l of Sn, 6.0 g/l of Cu, 15 g/l of the organic chelating agent (the aforementioned FCM-B, produced by FCM Co., Ltd.), and 30 cc/l of the additive (the aforementioned FCM-C, produced by FCM Co., Ltd.)) was used.

For the terminal obtained as such, samples were taken at points of 10 m and 90 m from an end thereof, and cross sections thereof were cut using the FIB apparatus to measure thicknesses thereof. As a result, the ground layer formed of Ni had a thickness of 1.1 μm, while a surface layer formed of the Sn—Cu binary alloy had a thickness of 3.5 μm.

In addition, an alloy ratio of the surface layer measured using the EPMA was 93.6 mass % of Sn and 6.4 mass % of Cu. A melting point of this surface layer was 287° C.

Though the surface layer of the terminal had the same Sn content as the surface layer of the terminal of example 2, the melting point thereof was increased by 70° C., and thus it had inferior solderability.

### Comparative Example 5

For the conductive base as used in example 1, a surface layer was formed by melting solder of an ingot of the Sn—Ag—Cu ternary alloy having the same composition as the Sn—Ag—Cu ternary alloy used in example 1.

The surface layer, however, had a thickness of no less than 100 μm, and the thickness was extremely uneven. When the surface layer was made to have a thickness of no more than 100 μm, on the other hand, many pinholes were generated and thus it had inferior corrosion resistance.

### Example 4

Copper in a tape-like form as the conductive base, which was rolled to have a thickness of 0.3 mm and a width of 30 mm and then pressed to have a form of a connector to be a continuous form of connector terminals, was cut to have a length of 100 m and taken up on a reel. The reel was then set on a feeding-out shaft of the continuous plating apparatus.

Then, the step of first washing was performed by continuously immersing the conductive base for 1 minute in an immersion bath of the continuous plating apparatus which was filled with an aqueous solution containing sodium hydroxide (using 50 g/l of Ace Clean 30 (produced by Okuno Chemical Industries Co., Ltd.), pH 12.5) at a solution temperature of 48° C. Thereafter, washing with water was performed for several times.

Thereafter, the step of second washing was performed by electrolyzing in an electrolytic bath of the continuous plating apparatus having an alkaline pH (using 100 g/l of NC Rustol (produced by Okuno Chemical Industries Co., Ltd.) as the aqueous solution of sodium hydroxide, pH 13.2) using the conductive base subjected to the first washing as a cathode at a solution temperature of 50° C. with a current density of 5 A/dm² for 1 minute, and then washing with water was again repeated for 5 times.

Then, the acid treatment with the acid for allowing the acid to act on the surface of the conductive base was performed by immersing the conductive base washed as such in an activation bath filled with sulfuric acid having a pH of 0.5 at a solution temperature of 30° C. for 1 minute. Thereafter, washing with water was repeated for 3 times.

Next, for the conductive base processed as described above, a step of forming the Sn layer formed of Sn with electroplating was performed. That is, the conductive base processed as described above was immersed in a plating bath of the continuous plating apparatus, the conductive base itself was used as a cathode while Sn was used as an anode, and the plating bath of the continuous plating apparatus was filled with 350 g/l of Sn methanesulfonate salt and 50 cc/l of an additive (trade name: Metasu SBS (produced by Yuken Industry Co., Ltd) to perform electroplating in a condition of a solution temperature of 35° C., pH 0.5 and a current density of 4 A/dm² for 2 minutes to form the Sn layer on the conductive base.

Subsequently, the step of forming the surface layer formed of the Sn—Ag—Cu ternary alloy on the Sn layer was performed by immersing the conductive base having the Sn layer formed thereon as described above in the plating bath of the continuous plating apparatus for electroplating. That is, the conductive base having the Sn layer formed thereon was used as a cathode while the electrode formed of Ti having the surface coated with Pt was used as an anode, and the plating bath of the continuous plating apparatus was filled with 260 g/l of the Sn compound (Sn methanesulfonate salt), 10 g/l of the Ag compound (Ag methanesulfonate salt), 2.5 g/l of the Cu compound (Cu methanesulfonate salt), 100 g/l of the inorganic chelating agent (potassium polyphosphate (KH)ₙ₊₂PₙO₃ₙ₊₁, molecular weight: 57.1+80n, n=5-11), 25 μl of the organic chelating agent (tetranaphthyl porphyrin), and 30 cc/l of the additive (polyethylene glycol) to perform electroplating in a condition of a solution temperature of 30° C., pH 0.5 and a current density of 4 A/dm² for 0.5 minutes to form the surface layer formed of the Sn—Ag—Cu ternary alloy on the Sn layer. Thereafter, washing with water was performed for 4 times, and drip-drying with air and drying with hot air of 70° C. for 2 minutes were performed to obtain the terminal of the present invention which had the Sn layer formed on the conductive base and the surface layer formed of the Sn—Ag—Cu ternary alloy formed on the Sn layer.

For the terminal obtained as such, samples were taken at points of 10 m and 90 m from an end thereof, and cross sections thereof were cut using the FIB apparatus to measure thicknesses thereof. As a result, the Sn layer had a thickness of 4 μm, while the surface layer formed of the Sn—Ag—Cu ternary alloy had a thickness of 1 μM, which thicknesses were uniform.

In addition, an alloy ratio of the surface layer formed of the Sn—Ag—Cu ternary alloy measured using the EPMA was 96 mass % of Sn, 3.6 mass % of Ag and 0.4 mass % of Cu. A melting point of the surface layer formed of the Sn—Ag—Cu ternary alloy was 215° C. and thus good solderability was shown. The surface layer formed of the Sn—Ag—Cu ternary alloy was formed in a state of a crystal of a minute particle (diameter of the particle: 1-3 μm) as compared with a thin film formed of Sn alone.

Furthermore, generation of the whisker was not observed when the surface layer formed of the Sn—Ag—Cu ternary alloy was kept in the high temperature and high humidity bath (60° C., 90% humidity) for 2000 hours. That is, the surface layer formed of the Sn—Ag—Cu ternary alloy which attains prevention of generation of the whisker concomitant with good solderability (that is, the low melting point) could be obtained.

Although the present invention has been described and illustrated in detail, it is clearly understood that the same is by way of illustration and example only and is not to be taken by way of limitation, the spirit and scope of the present invention being limited only by the terms of the appended claims.

1. A terminal obtained by forming a surface layer formed of an Sn—Ag—Cu ternary alloy with electroplating on a whole surface or a portion of a conductive base; wherein
said Sn—Ag—Cu ternary alloy is constructed with a ratio of 70-99.8 mass % of Sn, 0.1-15 mass % of Ag and 0.1-15 mass % of Cu, has a melting point of 210-230° C., and is formed in a state of a crystal of a minute particle as compared with said surface layer formed of Sn alone.

2. The terminal according to claim 1, wherein
said terminal is any of a connector terminal, a relay terminal, a slide switch terminal, and a soldered terminal.

3. A part having the terminal according to claim 1.

4. The part according to claim 3, wherein
said part is any of a connector, a relay, a slide switch, a resistance, a capacitor, a coil, and a substrate.

5. A product having the terminal according to claim 1.

6. The product according to claim 5, wherein
said product is any of a semiconductor product, an electrical product, an electronic product, a solar battery, and an automobile.

7. The terminal according to claim 1, wherein
said surface layer is formed in a condition of coexistence of at least two chelating agents.

8. The terminal according to claim 7, wherein
said chelating agents include at least an inorganic chelating agent and an organic chelating agent.

9. A method of manufacturing the terminal according to claim 1, comprising the step of
forming said surface layer formed of said Sn—Ag—Cu ternary alloy with electroplating on a whole surface or a portion of said conductive base; wherein
said step is performed in a condition of coexistence of at least two chelating agents.

10. The method of manufacturing the terminal according to claim 9, wherein
said chelating agents include at least an inorganic chelating agent and an organic chelating agent.
